(19) United States
(12) Patent Application Publication
(10) Pub. No.: US 2021/0364841 A1
(43) Pub. Date: Nov. 25, 2021

(54) LIQUID CRYSTAL DISPLAY PANEL, MANUFACTURING MEHTOD THEREOF AND DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Xibin Shao, Beijing (CN); Yingying Qu, Beijing (CN); Yujie Gao, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 16/334,079

(22) PCT Filed: Nov. 13, 2018
(86) PCT No.: PCT/CN2018/115160

§ 371 Date: Mar. 18, 2019

(30) Foreign Application Priority Data
Jan. 2, 2018 (CN) 201810001636.6

(51) Int. Cl. G02F 1/1339; G02F 1/1335

(52) U.S. Cl. CPC G02F 1/13394; G02F 1/133512; G02F 1/133514; G02F 1/13398

(57) ABSTRACT

A liquid crystal display panel is disclosed, including an array substrate (01) comprising a plurality of sub-pixels, an opposite substrate (02) opposite the array substrate (01), a liquid crystal layer (03) between the array substrate (01) and the opposite substrate (01), and a plurality of spacers (04) between the array substrate (01) and the opposite substrate (02). The plurality of spacers (04) may respectively be in areas between the adjacent sub-pixels. Each of the plurality of the spacers (04) may include a first sub-spacer (041) and a second sub-spacer (042). The first sub-spacer (041) may be formed on a side of the array substrate (01) facing the opposite substrate (02). The second sub-spacer (042) may be formed on a side of the opposite substrate (02) facing the array substrate (01). A side of the first sub-spacer (041) facing the opposite substrate (02) may be in contact with a side of the second sub-spacer (042) facing the array substrate (01).

### CROSS-REFERENCE TO RELATED APPLICATIONS

This application claims benefit of the filing date of Chinese Patent Application No. 201810001636.6 filed on Jan. 2, 2018, the disclosure of which is hereby incorporated in its entirety by reference.

### TECHNICAL FIELD

The present disclosure relates to display technology, in particular, to a liquid crystal display panel, a manufacturing method thereof, and a display apparatus.

### BACKGROUND

A Liquid crystal display panel (LCD) is generally formed by pairing a color film substrate and an array substrate to form a cell. A liquid crystal layer is sandwiched between the color film substrate and the array substrate. In order to ensure uniformity of thickness of the liquid crystal layer, it is usually necessary to provide spacers for supporting the substrates.

In the present liquid crystal display panels, the spacers are generally disposed on the color film substrate. After pairing the color film substrate and the array substrate, a side of each of the spacers facing away from the color film substrate touches the array substrate. Under action of an external force, the spacers can be compressed and slide over a large distance to scratch alignment films in pixel opening regions, thereby resulting in disordered alignment of the liquid crystals and eventually poor bright spots.

### BRIEF SUMMARY

An embodiment of the present disclosure provides a liquid crystal display panel. The liquid crystal display panel may include an array substrate comprising a plurality of sub-pixels, an opposite substrate opposite the array substrate, a liquid crystal layer between the array substrate and the opposite substrate, and a plurality of spacers between the array substrate and the opposite substrate. The plurality of the spacers is respectively in areas between the adjacent sub-pixels. Each of the plurality of the spacers may include a first sub-spacer and a second sub-spacer, the first sub-spacer is formed on a side of the array substrate facing the opposite substrate, the second sub-spacer is formed on a side of the opposite substrate facing the array substrate, and a side of the first sub-spacer facing the opposite substrate is in contact with a side of the second sub-spacer facing the array substrate.

An orthographic projection of the first sub-spacer on the opposite substrate may be located inside an orthogonal projection of the second sub-spacer on the opposite substrate. Both the orthographic projection of the first sub-spacer on the opposite substrate and the orthographic projection of the second sub-spacer on the opposite substrate may have a circular shape. An orthogonal projection of the second sub-spacer on the array substrate may be located inside an orthogonal projection of the first sub-spacer on the array substrate. Both the orthographic projection of the first sub-spacer on the array substrate and the orthographic projection of the second sub-spacer on the array substrate may have a circular shape.

In one embodiment, a cross-section of at least one of the first sub-spacer and the second sub-spacer in a plane parallel to the array substrate is a rectangular shape. In one embodiment, both cross-sections of the first sub-spacer and the second sub-spacer in a plane parallel to the array substrate are a rectangular shape. An orthographic projection of the first sub-spacer on the array substrate and an orthogonal projection of the second sub-spacer on the array substrate may form a cross shape.

The liquid crystal display panel may further include a photoresist layer on the side of the opposite substrate facing the array substrate. The second sub-spacer and the photoresist layer may be made of a same material and located in a same layer.

The liquid crystal display panel may further include a photoresist layer on the side of the array substrate facing the opposite layer. The first sub-spacer and the photoresist layer may be made of a same material and located in a same layer. The photoresist layer may include color films of three colors of red, green, and blue.

The liquid crystal display panel may further include a black matrix layer between the array substrate and the opposite substrate. An orthogonal projection of the plurality of spacers on the array substrate may be located inside orthogonal projection of the black matrix layer on the array substrate.

Another example of the present disclosure is a display apparatus comprising the liquid crystal display panel according to one embodiment of the present disclosure.

Another example of the present disclosure is a method of manufacturing a liquid crystal display panel. The method of manufacturing a liquid crystal display panel may include forming a plurality of first sub-spacers on an array substrate, forming a plurality of second sub-spacers on an opposite substrate, and pairing the array substrate and the opposite substrate to form a cell. A side of each of the plurality of the first sub-spacers facing the opposite substrate may be in contact with a side of one of the plurality of the second sub-spacers facing the array substrate.

The method of manufacturing the liquid crystal display panel may further include, after paring the array substrate and the opposite substrate to form the cell, disposing a liquid crystal layer between the array substrate and the opposite substrate.

Forming the plurality of the first sub-spacers on the array substrate further may include forming a photoresist layer having a plurality of colors on the array substrate. The plurality of the first sub-spacers and the photoresist layer having one of the plurality of colors may be formed by one patterning process. Forming the plurality of the second sub-spacers on the opposite substrate may further include forming a photoresist layer having a plurality of colors on the opposite substrate. The plurality of the second sub-spacers and the photoresist layer having one of the plurality of colors may be formed by one patterning process.

### BRIEF DESCRIPTION OF THE DRAWINGS

The subject matter which is regarded as the disclosure is particularly pointed out and distinctly claimed in the claims at the conclusion of the specification. The foregoing and other objects, features, and advantages of the disclosure are apparent from the following detailed description taken in conjunction with the accompanying drawings in which:

FIG. 1 is a schematic structural diagram of a liquid crystal display panel according to an embodiment of the present disclosure.

FIG. 2 is a schematic structural diagram of a liquid crystal display panel provided before pairing according to an embodiment of the present disclosure.

FIG. 3 is a schematic structural diagram of a liquid crystal display panel according to an embodiment of the present disclosure.

FIG. 4 is a schematic structural diagram of a liquid crystal display panel according to an embodiment of the present disclosure.

FIG. 5 is a schematic structural diagram of a liquid crystal display panel according to an embodiment of the present disclosure.

FIG. 6 is a schematic structural diagram of a liquid crystal display panel according to an embodiment of the present disclosure.

FIG. 7 is a schematic structural diagram of a liquid crystal display panel according to an embodiment of the present disclosure.

FIG. 8 is a flowchart of a method for manufacturing a liquid crystal display panel according to an embodiment of the present disclosure.

### DETAILED DESCRIPTION

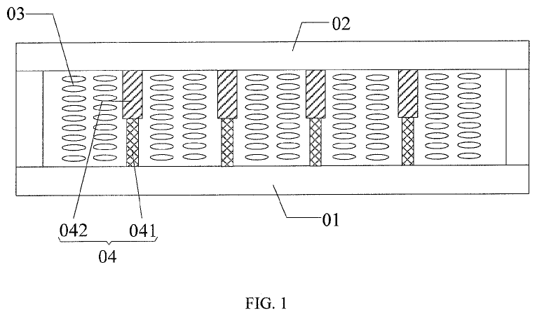

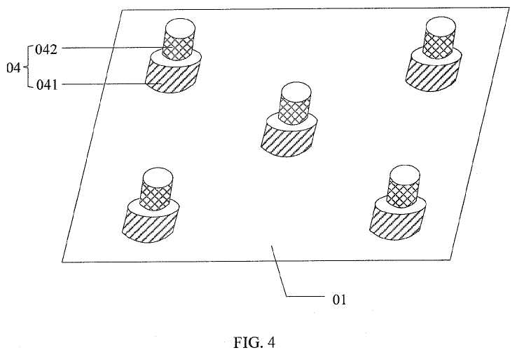

The present disclosure will be described in further detail with reference to the accompanying drawings and embodiments in order to provide a better understanding by those skilled in the art of the technical solutions of the present disclosure. Throughout the description of the disclosure, reference is made to FIGS. 1-8. When referring to the figures, like structures and elements shown throughout are indicated with like reference numerals.

The shapes and sizes of components in the drawings do not reflect true scale and are only intended to schematically illustrate content of the present disclosure.

A liquid crystal display panel provided by an embodiment of the present disclosure, as shown in FIG. 1, includes an array substrate 01, an opposite substrate 02 opposite the array substrate 01, a liquid crystal layer 03 between the array substrate 01 and the opposite substrate 02, and a plurality of spacers 04 between the array substrate 01 and the opposite substrate 02 for supporting and maintaining the thickness of the liquid crystal layer 03.

The array substrate 01 has a plurality of sub-pixels arranged in a matrix. The spacers 04 are respectively located between adjacent sub-pixels.

The spacer 04 includes a first sub-spacer 041 and a second sub-spacer 042. The first sub-spacer 041 is formed on the side of the array substrate 01 facing the opposite substrate 02, and the second sub-spacer 042 is formed on the side of the opposite substrate 02 facing the array substrate 01. The side of the first sub-spacer 041 facing the opposite substrate 02 and the side of the second sub-spacer 042 facing the array substrate 01 are in contact with each other.

In the liquid crystal display panel provided by the embodiments of the present disclosure, the spacers are respectively located between adjacent sub-pixels, and each of the spacers includes a first sub-spacer and a second sub-spacer. The first sub-spacer is formed on the side of the array substrate facing the opposite substrate, and the second sub-spacer is formed on the side of the opposite substrate facing the array substrate. The side of the first sub-spacer facing the opposite substrate and the side of the second sub-spacer facing the array substrate are in contact with each other. As such, the contacting surface between the first sub-spacer and the second sub-spacer protrudes over surface of the alignment film in the sub-pixel regions. Thus, even if a relative slide occurs between the first sub-spacer and the second sub-spacer under an external force, the alignment film in the sub-pixel region is not scratched because the contacting surface of the first sub-spacer and the second sub-spacer are floating over the alignment film in the sub-pixel region.

In one embodiment, when the liquid crystal display panel is manufactured, the opposite substrate and the array substrate are separately fabricated. After the desired film layers are prepared respectively on the array substrate and the opposite substrate, the array substrate and the opposite substrate are paired to form a cell. Liquid crystals are then filled between the array substrate and the opposite substrate to form the liquid crystal display panel.

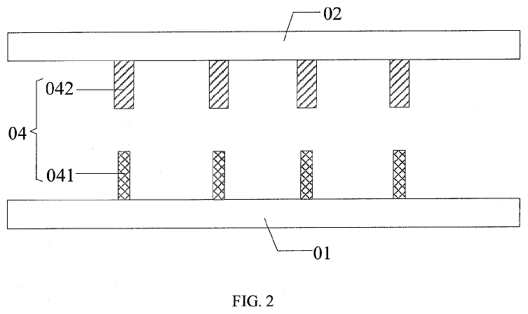

In one embodiment, in the process of manufacturing the liquid crystal display panel, before the array substrate 01 and the opposite substrate 02 are paired, as shown in FIG. 2, the first sub-spacers 041 are formed on the side of array substrate 01 facing the opposite substrate 02, and the second sub-spacers 042 are formed on the side of the opposite substrate 02 facing the array substrate 01.

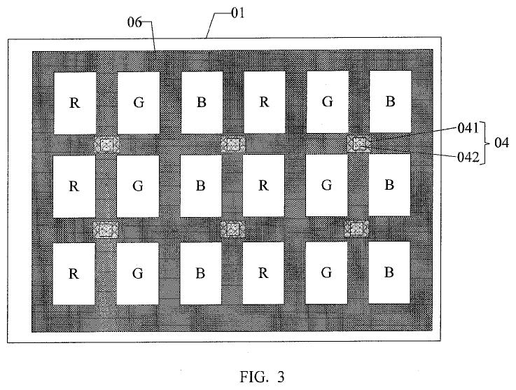

In one embodiment, as shown in FIG. 3, the areas between adjacent sub-pixels are generally used to accommodate components such as signal lines and thin film transistors (not shown in FIG. 3). Therefore, there is no display in the areas between adjacent sub-pixels. Only the area where the sub-pixels are located can be used for display, that is, the pixel's opening region. To avoid mixing colors, a black matrix layer 06 is generally disposed between adjacent sub-pixels. To prevent the spacers from occupying the pixel's opening regions, in the liquid crystal display panel provided by the embodiment of the present disclosure, the spacers 04 are disposed in the area where the black matrix layer 06 is located.

In one embodiment, in the liquid crystal display panel provided by the embodiment of the present disclosure, as shown in FIG. 3, a black matrix layer 06 located between the array substrate 01 and the opposite substrate 02 is also included (the opposite substrate is not seen in FIG. 3).

The orthogonal projection of the spacers 04 on the array substrate 01 is located inside the orthogonal projection of the black matrix layer 06 on the array substrate 01. That is, the spacers 04 do not occupy the effective display area of the liquid crystal display panel, so that the aperture ratio of the liquid crystal display panel can be maintained. In addition, because the projection of the spacers 04 is located inside the projection of the black matrix layer 06, when the first sub-spacer 041 and the second sub-spacer 042 slide against each other under action of an external force, they can be prevented from sliding to the pixels' opening regions immediately.

In one embodiment, in the liquid crystal display panel provided by the embodiment of the present disclosure, as shown in FIG. 1, for the spacer 04, the orthographic projection of the first sub-spacer 041 on the opposite substrate 02 is located inside the orthogonal projection of the second sub-spacer 042 on the opposite substrate 02. Therefore, the contacting area between the first sub-spacer 041 and the second sub-spacer 042 is maximized to avoid sliding under action of an external force. On the other hand, even if the first sub-spacer 041 and the second sub-spacer 042 slide relatively against each other, the first sub-spacer 041 cannot easily slide out of the area where the second sub-spacer 042 is located, thereby preventing both the first sub-spacer 041 and the second sub-spacer 042 from being suspended so that they cannot serve as a support.

In one embodiment, in the liquid crystal display panel provided by the embodiment of the present disclosure, as shown in FIG. 3 to FIG. 5, for the spacer 04, the orthogonal projection of the second sub-spacer 042 on the array substrate 01 is located inside the orthogonal projection of the first sub-spacer 041 on the array substrate 01. Therefore, the contacting area between the first sub-spacer 041 and the second sub-spacer 042 is maximized to avoid sliding under action of an external force. On the other hand, even if the first sub-spacer 041 and the second sub-spacer 042 slide relatively against each other, the second sub-spacer 042 cannot easily slide out of the area where the first sub-spacer 041 is located, thereby preventing both the sub-spacer 041 and the second sub-spacer 042 from being suspended so that they cannot serve as a support.

In the liquid crystal display panel provided by the embodiments of the present disclosure, the shapes of the first sub-spacer and the second sub-spacer are not limited, and they may be a regular shape or an irregular shape.

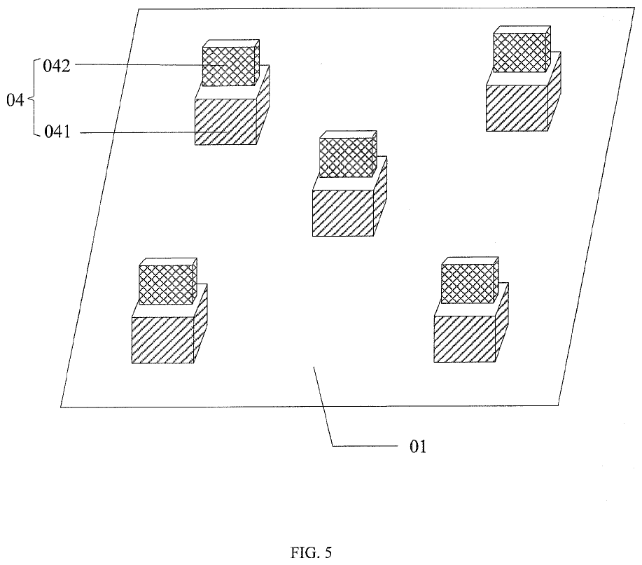

In one embodiment, in the liquid crystal display panel provided by one embodiment of the present disclosure, as shown in FIG. 5, for the spacer 04, at least one of the first sub-spacer 041 and the second sub-spacer 042 is presented in a “ [symbol] ” shape, that is, a narrow rectangular shape. For example, in FIG. 5, the second sub-spacer 042 is in a “ [symbol] ” shape, that is, a narrow rectangular shape. The first sub-spacer 041 is also a rectangle. It should be noted that the “ [symbol] ” shape or the narrow rectangular shape of the sub-spacer indicates that the shape of the orthographic projection of the sub-spacer on the array substrate is a “ [symbol] ” shape or a narrow rectangular shape, or the shape of the orthographic projection of the sub-spacer on the opposite substrate is a “ [symbol] ” shape or a narrow rectangular shape.

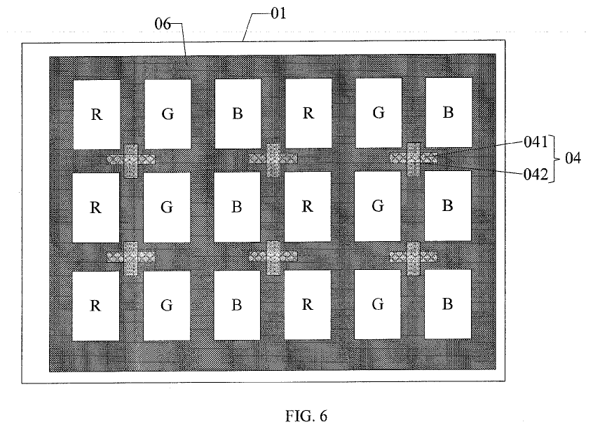

In one embodiment, in the liquid crystal display panel provided by one embodiment of the present disclosure, as shown in FIG. 6, for the spacer 04, both the first sub-spacer 041 and the second sub-spacer 042 have a “ [symbol] ” shape or a narrow rectangular shape. The orthographic projection of the first sub-spacer object 041 on the array substrate 01 and the orthogonal projection of the second sub-spacer 042 on the array substrate 01 constitute a “ [symbol] ” shape or a cross shape in order to increase friction between the sub-spacers, thereby preventing the sub-spacers from generating a large slide under action of an external force.

In one embodiment, in the liquid crystal display panel, a thin film transistor array, a pixel electrode layer connected to the thin film transistor, an alignment film layer, and the like are also provided on the array substrate.

In one embodiment, in the liquid crystal display panel, a color photoresist layer, i.e., a color film layer corresponding to a sub-pixel is generally disposed on the opposite substrate. The color film layer may be, for example, a color film layer corresponding to RGB sub-pixels, RGBW sub-pixels, or RGBY sub-pixels, which are not limited here. Therefore, the opposite substrate is also generally referred to as a color film substrate. A common electrode layer, a black matrix layer, an alignment film layer, and the like are also generally provided on the opposite substrate. Of course, in one embodiment, the color photoresist layer, the common electrode layer, and the black matrix layer may also be disposed on the array substrate, which is not limited herein.

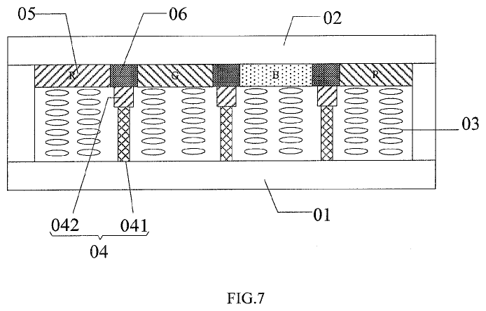

In one embodiment, in the liquid crystal display panel, as shown in FIG. 7, a photoresist layer 05 is provided on the side of the opposite substrate 02 facing the liquid crystal layer 03.

In one embodiment, the second sub-spacer 042 and the photoresist layer 05 are made of the same material and located in the same layer. In this way, the second sub-spacer 042 and the photoresist layer 05 can be formed by a single patterning process. As a result, a masking process for fabricating the second sub-spacers 042 can be omitted. As such, compared with the prior art, although the spacer is divided into two parts, the masking process is still performed one time. Therefore, compared with the prior art, the number of masking processes is not increased.

In one embodiment, in the liquid crystal display panel, a photoresist layer is provided on the side of the array substrate facing the liquid crystal layer.

The first sub-spacer and the photoresist layer are made of the same material and located in the same layer. In this way, the first sub-spacer and the photoresist layer can be formed by a single patterning process. As a result, a masking process for making the first sub-spacer can be omitted. As such, compared with the prior art, although the spacer is divided into two parts, the masking process is still performed one time. Therefore, compared with the prior art, the number of masking processes is not increased.

It should be noted that, in the liquid crystal display panel provided by the embodiments of the present disclosure, the sub-spacer and the photoresist layer are located in the same layer. As used herein, the term “same layer” refers to the relationship between the layers simultaneously formed in the same step. The term “same layer” does not always mean that the thickness of the layers or the height of the layers in a cross-sectional view is the same.

Based on the same inventive concept, an embodiment of the present disclosure further provides a manufacturing method of the above liquid crystal display panel. Since the principle of the manufacturing method is similar to that of the aforementioned liquid crystal display panel, implementation of the manufacturing method may refer to the above embodiments of the liquid crystal display panel, which will not be repeated here.

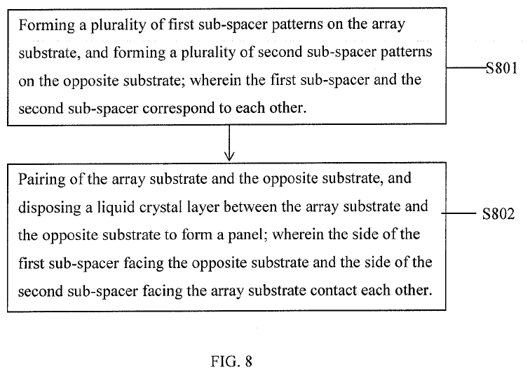

In a method of manufacturing a liquid crystal display panel provided by an embodiment of the present disclosure, as shown in FIG. 8, the method includes the following steps:

In step S801, a plurality of first sub-spacer patterns is formed on the array substrate, and a plurality of second sub-spacer patterns is formed on the opposite substrate. The first sub-spacers correspond to the second sub-spacers in a one-to-one correspondence.

In step S802, the array substrate and the opposite substrate are paired to form a cell. Then, a liquid crystal layer is disposed between the array substrate and the opposite substrate to form the panel. The side of the first sub-spacer facing the opposite substrate and the side of the second sub-spacer facing the array substrate are in contact with each other.

In one embodiment, in the manufacturing method, a plurality of first sub-spacer patterns may be formed on the array substrate first, and then a plurality of second sub-spacer patterns may be formed on the opposite substrate. Of course, a plurality of second sub-substrate patterns may be formed on the opposite substrate first, and then a plurality of first sub-spacer patterns may be formed on the array substrate, and the sequence is not limited herein.

In one embodiment, in the manufacturing method, when the photoresist layer is located on the side of the array substrate facing the liquid crystal layer, forming the plurality of the first sub-spacer patterns on the array substrate further includes forming a pattern of a photoresist layer of at least one color on the array substrate. Furthermore, during forming a pattern of a photoresist layer of one of the colors, a plurality of the first sub-spacer patterns is formed simultaneously by one patterning process.

In one embodiment, in the manufacturing method, when the photoresist layer is located on the side of the opposite substrate facing the liquid crystal layer, forming the plurality of second sub-spacer patterns on the opposite substrate further includes forming a pattern of a photoresist layer of at least one color on the opposite substrate. Furthermore, during forming a pattern of a photoresist layer of one of the colors, a plurality of the second sub-spacer patterns is formed simultaneously by one patterning process.

In one embodiment, a photoresist layer having three colors of red, green, and blue is provided on the opposite substrate. A patterning process is required for forming a pattern of a photoresist layer of each color on the opposite substrate. Thus, forming the pattern of the photoresist layer having three colors of red, green, and blue requires performing the patterning process three-times. When the pattern of the photoresist layer of any of the colors is formed, the patterning process can be changed so that the pattern of the photoresist layer and the plurality of the second sub-spacer patterns can be formed at the same time. This will reduce the number of masking processes. That is, in forming spacers of a liquid crystal display panel, only one masking process needs to be added. Compared with the prior art, the number of masking processes is the same.

It should be noted that, in the above manufacturing method provided by the embodiments of the present disclosure, the patterning process may include only a photolithography process, or include a photolithography process and an etching step. The patterning process may also further include printing, inkjeting, and other processes for forming a predetermined pattern. The photolithography process may refer to a process including film formation, exposure, and development which utilizes a photoresist, a mask plate, an exposure machine, or the like to form a pattern. In the specific implementation, an approximate patterning process may be selected according to the structure formed in the present disclosure.

One embodiment of the present disclosure further provides a display apparatus. The display apparatus may include any one of the foregoing liquid crystal display panels provided by the embodiments of the present disclosure. The display apparatus may be any product or component having a display function such as a mobile phone, a tablet computer, a television, a monitor, a notebook computer, a digital photo frame, a navigator, and the like. For the implementation of the display apparatus, reference may be made to the above embodiments of the liquid crystal display panel, which are not repeated herein.

A liquid crystal display panel, a manufacturing method thereof, and a display apparatus provided by the embodiments of the present disclosure are disclosed. The spacers are respectively located between adjacent sub-pixels, and each of the spacers includes a first sub-spacer and a second sub-spacer. The first sub-spacers are formed on the side of the array substrate facing the opposite substrate. The second sub-spacers are formed on the side of the opposite substrate facing the array substrate. The side of the first sub-spacer facing the opposite substrate is in contact with the side of the second sub-spacer facing the array substrate. Since the contacting surface of the first sub-spacer and the second sub-spacer protrudes over the surface of the alignment films in the sub-pixel regions, even if relative slide occurs between the first sub-spacer and the second sub-spacer under action of an external force, the first sub-spacer and the second sub-spacer are also floating over the alignment film in the sub-pixel region. As such, the alignment film in the sub-pixel region is not scratched.

The principle and the embodiment of the present disclosures are set forth in the specification. The description of the embodiments of the present disclosure is only used to help understand the method of the present disclosure and the core idea thereof. Meanwhile, for a person of ordinary skill in the art, the disclosure relates to the scope of the disclosure, and the technical scheme is not limited to the specific combination of the technical features, and also should covered other technical schemes which are formed by combining the technical features or the equivalent features of the technical features without departing from the inventive concept. For example, technical scheme may be obtained by replacing the features described above as disclosed in this disclosure (but not limited to) with similar features.

1. A liquid crystal display panel, comprising
an array substrate comprising a plurality of sub-pixels;
an opposite substrate opposite the array substrate;
a liquid crystal layer between the array substrate and the opposite substrate; and
a plurality of spacers between the array substrate and the opposite substrate;
wherein the plurality of the spacers are respectively in areas between the adjacent sub-pixels; and
each of the plurality of the spacers includes a first sub-spacer and a second sub-spacer, the first sub-spacer is formed on a side of the array substrate facing the opposite substrate, the second sub-spacer is formed on a side of the opposite substrate facing the array substrate, and a side of the first sub-spacer facing the opposite substrate is in contact with a side of the second sub-spacer facing the array substrate.

2. The liquid crystal display panel according to claim 1, wherein an orthographic projection of the first sub-spacer on the opposite substrate is located inside an orthogonal projection of the second sub-spacer on the opposite substrate.

3. The liquid crystal display panel according to claim 2, wherein both the orthographic projection of the first sub-spacer on the opposite substrate and the orthographic projection of the second sub-spacer on the opposite substrate have a circular shape.

4. The liquid crystal display panel according to claim 1, wherein an orthogonal projection of the second sub-spacer on the array substrate is located inside an orthogonal projection of the first sub-spacer on the array substrate.

5. The liquid crystal display panel according to claim 4, wherein both the orthographic projection of the first sub-spacer on the array substrate and the orthographic projection of the second sub-spacer on the array substrate have a circular shape.

6. The liquid crystal display panel according to claim 1, wherein a cross-section of at least one of the first sub-spacer and the second sub-spacer in a plane parallel to the array substrate is a rectangular shape.

7. The liquid crystal display panel according to claim 6, wherein both cross-sections of the first sub-spacer and the second sub-spacer in a plane parallel to the array substrate are a rectangular shape.

8. The liquid crystal display panel according to claim 7, wherein an orthographic projection of the first sub-spacer on the array substrate and an orthogonal projection of the second sub-spacer on the array substrate form a cross shape.

9. The liquid crystal display panel according to claim 1, further comprising a photoresist layer on the side of the opposite substrate facing the array substrate;
wherein the second sub-spacer and the photoresist layer are made of a same material and located in a same layer.

10. The liquid crystal display panel according to claim 1, further comprising a photoresist layer on the side of the array substrate facing the opposite layer;
wherein the first sub-spacer and the photoresist layer are made of a same material and located in a same layer.

11. The liquid crystal display panel according to claim 9 claim 9, wherein the photoresist layer comprises color films of three colors of red, green, and blue.

12. The liquid crystal display panel according to claim 1, further comprising a black matrix layer between the array substrate and the opposite substrate;
wherein orthogonal projection of the plurality of spacers on the array substrate are located inside orthogonal projection of the black matrix layer on the array substrate.

13. A display apparatus comprising the liquid crystal display panel according to claim 1.

14. A method of manufacturing a liquid crystal display panel, comprising:
forming a plurality of first sub-spacers on an array substrate;
forming a plurality of second sub-spacers on an opposite substrate; and
pairing the array substrate and the opposite substrate to form a cell;
wherein a side of each of the plurality of the first sub-spacers facing the opposite substrate is in contact with a side of one of the plurality of the second sub-spacers facing the array substrate.

15. The method of manufacturing the liquid crystal display panel according to claim 14, after paring the array substrate and the opposite substrate to form the cell, further comprising disposing a liquid crystal layer between the array substrate and the opposite substrate.

16. The method of manufacturing the liquid crystal display panel according to claim 15, wherein forming the plurality of the first sub-spacers on the array substrate further comprises forming a photoresist layer having a plurality of colors on the array substrate,
wherein the plurality of the first sub-spacers and the photoresist layer having one of the plurality of colors are formed by one patterning process.

17. The manufacturing method according to claim 15, wherein forming the plurality of the second sub-spacers on the opposite substrate further comprises forming a photoresist layer having a plurality of colors on the opposite substrate,
wherein the plurality of the second sub-spacers and the photoresist layer having one of the plurality of colors are formed by one patterning process.
